(19) United States
(12) Patent Application Publication
(10) Pub. No.: US 2026/0126301 A1
(43) Pub. Date: May 7, 2026

(54) Light Vehicle and Methods for Navigation Using a Portable Wireless Communication Terminal and a Bicycle Screen

(71) Applicant: Robert Bosch GmbH, Stuttgart (DE)

(72) Inventors: Martin Mathes, Fulda (DE); Peter Kunakh, Lund (SE)

(21) Appl. No.: 19/120,662

(22) PCT Filed: Oct. 11, 2023
(86) PCT No.: PCT/EP2023/078173

§ 371 Date: Apr. 11, 2025

(30) Foreign Application Priority Data
Oct. 20, 2022 (DE) 10 2022 211 140.0

(51) Int. Cl. G01C 21/00; G01C 21/20

(52) U.S. Cl. CPC G01C 21/3885; G01C 21/20

(57) ABSTRACT

A light vehicle and methods for navigation using a portable wireless communication terminal and a bicycle screen are disclosed. One of the methods include computing a first data packet representing map information by way of the wireless communication terminal and transmitting the first data packet to the bicycle screen, and computing a second data packet representing an ego position of the wireless communication terminal by way of the wireless communication terminal and transmitting the second data packet to the bicycle screen, receiving a first data packet representing map information from the wireless communication terminal and displaying the map information on the bicycle screen, and receiving a second data packet representing an ego position of the wireless communication terminal from the wireless communication terminal and displaying the ego position on the bicycle screen.

### PRIOR ART

The present invention relates to a light vehicle and a method for navigation using a portable wireless communication terminal and a bicycle screen. In particular, the present invention relates to a user-friendly and visually appealing as well as data traffic-friendly solution for using a smartphone with a bicycle screen (display) attached to the bicycle.

Smartphones are now equipped with navigation systems that can handle the display and audio output of navigation plans completely independently. The position is determined using the smartphone's sensors and the map material for displaying the road map is provided via antennas or internal memory. However, smartphones are usually quite fragile and susceptible to moisture, such that using them on the handlebars of a light vehicle (e.g. e-bike, S-pedelec, pedelec, etc.) does not always seem advisable. This applies in particular to uneven or off-road terrain. However, not having the smartphone capabilities that the user may have purchased available for navigation plans means a reduction in the user experience or the need to purchase appropriate map material for more robust, possibly brighter and/or larger bicycle screens.

### Disclosure of the Invention

Starting from the aforementioned prior art, it is a task of the present invention to eliminate the aforementioned disadvantages also for users of light vehicles.

The aforementioned task is solved according to the invention by methods for navigation using a portable wireless communication terminal (e.g. a smartphone, a tablet, a smart wearable, or the like) and a bicycle screen. A first method relates to the method steps according to the invention, which are carried out in the wireless communication terminal. In this method, a first data packet representing map information is computed by means of the portable wireless communication terminal. The first data packet can also be understood as a data stream or the result of a data processing procedure which is carried out in an evaluation unit of the wireless communication terminal. The map information can be independent of the current orientation of the smartphone, the bicycle screen and, in particular, a light vehicle. In other words, the map information represented in this sense by the first data packet is the same for every user who uses the corresponding software package. In particular, the map information is identical regardless of the current position and/or the current orientation and/or the display size used. In particular, the map information therefore does not contain any information that has been ascertained or adapted as a function of the current navigation plan. The first data packet is then transmitted to the bicycle screen. This can be done using a Bluetooth connection, a Bluetooth low-energy connection, a WiFi/WLAN connection or the like. In particular, a separate channel can be set up between the wireless communication terminal and the bicycle screen for the first data packet and the data packet following the first data packet (updated first data packets). The bicycle screen can be connected directly or (via an electronic control unit with an evaluation unit located on the light vehicle) to the wireless communication terminal. (Partial) wired communication between the wireless communication terminal and the bicycle screen is also possible. For example, the wireless communication terminal can establish a wireless connection to a light vehicle or light motorcycle, in which a communication unit receives the data packets and then forwards them by cable to the bicycle screen. In addition, a second data packet is computed by means of the wireless communication terminal device, which represents an ego position of the wireless communication terminal device. The information contained in the second data packet is therefore to be understood as additional information that provides the bicycle screen with information on the ego position and/or orientation and/or zoom level. The ego position includes, for example, a position characteristic, a direction characteristic and a speed characteristic. The speed characteristic can be provided by the smartphone and/or the electric bicycle. The ego position information can be transmitted directly from bike sensors to the vehicle or bicycle screen and/or from bicycle sensors to the smartphone.

The vehicle may feature a Bluetooth receiver for this purpose, which forwards the data packets to the bicycle screen by wire. The second data packet is transmitted to the bicycle screen separate from the first data packet. The second data package does not contain any map data, such that updating the map data as well as the ego position or other riding situation-related information can update the bicycle screen completely independently of the map material. The second data packet can also be transmitted wirelessly or via a separate channel to the bicycle screen, as described in connection with the first data packet. The bicycle screen or the bicycle and/or a control unit of the same can now combine the information contained in the first and second data packets such that a display representing the current riding situation and position of the wireless communication terminal or the bicycle screen results on the bicycle screen. The means of transportation, in particular the bicycle screen, therefore determines a bicycle screen display based on the first and second data packets provided and displays it. In particular, no map data are to be transmitted to the bicycle screen if the information required to display the riding situation on the bicycle screen (map material) is available. Conversely, no new information or route history needs to be transmitted to the bicycle screen if the user merely adjusts the zoom level of the bicycle screen, while new map material may need to be transmitted to the bicycle screen by means of initial data packets from the wireless communication terminal. This can reduce the data communication between the wireless communication terminal and the bicycle screen and reduce the computing effort required to send, receive and process the data.

According to a second aspect of the present invention, the steps of the method according to the invention to be carried out in the bicycle screen are protected. The bicycle screen may feature or interact with an evaluation unit such that the bicycle screen communicates either directly or indirectly with the wireless communication terminal described above. In a first step, the first data packet computed and transmitted by the wireless communication terminal representing the map information is received and then the map information is stored on the bicycle screen. In other words, the map information represented in the first data packet is kept ready for the creation of a map information display. To complete the information to be displayed, the second data packet is also received from the wireless communication terminal, which contains the ego position but no map data. For the wireless communication terminal, the bicycle screen as well as the data packets and the communication and hardware of the second aspect of the invention, the above applies in a corresponding manner, such that reference is made to the above explanations in order to avoid repetition. After merging the information contained in the first and second data packets, a navigation display (map or route with ego position or arrow navigation display) is then rendered and displayed on the bicycle screen.

The dependent claims show preferred further modifications of the invention.

The second data packet may further comprise or represent (in addition to the ego position) a target orientation of the map information or map display and/or a zoom command (e.g. intersection zoom) and/or a display setting or display information such as a resolution of the bicycle screen, a size of the bicycle screen, aspect ratio of the bicycle screen, or the like. In this way, the second data packet may better prepare the display of the map information on the bicycle screen and the display content may already be adapted in the wireless communication terminal to the requirements and characteristics of the bicycle screen.

The first data packet and/or the second data packet may be transmitted to the bicycle screen as vector data. This has the advantage that, regardless of the pixel display actually used, the control unit receiving the data packets can guarantee a flexible, visually appealing and fluid display of the navigation plan. In particular, the vector data in the bicycle screen may be used to display smooth edges and a high level of detail regardless of the current zoom level.

In a corresponding manner, the first data packet and/or the second data packet can be transmitted to the bicycle screen as rasterized data (pixel data or pixel representation). Rasterizing the data can reduce the computing power required in the bicycle screen because the display options are already taken into account in the wireless communication terminal. For this purpose, the wireless communication terminal can receive information regarding the display properties of the bicycle screen initially and/or during the navigation plan in order to be able to adapt the size, resolution, aspect ratio and other parameters to the hardware of the bicycle screen in the best possible way. This can apply in particular to the navigation map, but alternatively or additionally also to the display of the ego position and the route ahead (sometimes highlighted in blue, for example).

For example, the first data packet can be transmitted to the bicycle screen on an event basis. For example, it can be determined that the bicycle screen requires segments of the map information in order to be able to display areas traveled by the wireless communication terminal in the future at the present time. For this purpose, the bicycle screen can transmit a third data packet to the wireless communication terminal, which causes it to transmit an (updated) first data packet with corresponding map data to the bicycle screen. Alternatively, the first and second data packets are actively “pushed” from the wireless communication terminal to the bicycle display. In this case, the smartphone automatically detects whether it needs to transmit more data. The second data packet can be transmitted to the bicycle screen at regular intervals, for example. In particular, the time intervals can be selected as a function of a current travel speed in order to ensure a smooth display of the current position of the wireless communication terminal. The time intervals can be regular, preferably 0.1 Hz to 100 Hz, preferably 0.5 Hz to 20 Hz, more preferably 1-2 Hz or irregular. All data packets of the method according to the invention can alternatively or additionally be transmitted on an event basis. Another event for sending an (updated) first data packet can be the (manual or automatic) zoom of the map information on the bicycle screen. This event can also lead to map data being required on the bicycle screen that was not previously required. This can also be used as an event for transmitting (updated) initial map data to the wireless communication terminal.

Preferably, a further (updated) navigation display can be determined by the bicycle screen based on a speed parameter which is determined using the previously received (previous) second data packet. For example, a speed can be determined from the position information of the first data packets received at different times without having to use speed or position sensors of the means of transportation or the bicycle screen. The use of speed or position sensors of the means of transport or the bicycle screen is of course possible as an alternative or in addition. In particular, a speed using wheel speed sensors, an orientation using a digital compass and/or a direction using a satellite-based positioning device can be used.

The wireless communication terminal can determine the ego position independently, as is usually the case with stand-alone applications in smartphones. The wireless communication terminal receives the time-stamped data from satellites and uses it to determine its own position and the respective time stamp. Alternatively or additionally, an ego position and/or an orientation can be received from a (for example electrically driven) light vehicle, in particular a pedelec or an e-bike or an S-pedelec or the bicycle screen itself, and these can be taken into account in the second data packet. This can provide a broader information basis for localization and/or conserve the energy resources of the wireless communication terminal device.

In particular, the first data packet and the second data packet have not been computed or transmitted by an identical information technology instance. Rather, they may have been created by the same program or APP, but the underlying routines and processes may correspond to different boundary conditions and/or cycles. However, the first and second data packets can essentially be transmitted at the same time or interleaved with each other, but are also logically decoded or combined separately by the receiver (the light vehicle or its bicycle screen) and only then combined in a common screen display.

The second data packet can be computed and/or transmitted more frequently, in particular five times, in particular ten times, preferably one hundred times more frequently than the first data packet. Alternatively or additionally, the first data packet can have a data volume that corresponds to at least ten times, preferably one hundred times, the data volume of the second data packet. This means that the current ego position can always be tracked visually “smoothly” without unnecessarily high data traffic.

With the method according to the invention, the IT performance provided by a possibly fragile or moisture-sensitive smartphone can be used on robust and possibly smaller quantities of manufactured external bicycle screens without unnecessarily increasing the data communication.

According to a third aspect of the present invention, a light vehicle, in particular an electrically propelled bicycle, is proposed which features a bicycle screen and is adapted to perform a method according to any of the preceding claims in connection with a wireless communication terminal (e.g. smartphone, tablet, smart wearable, or the like) of a user. The light vehicle can be designed, for example, as a bicycle, electrically powered bicycle, cargo bike, pedelec, S-pedelec, e-bike or similar. In particular, it can be a light vehicle without a closed passenger compartment, such that the bicycle screen must be designed to be dust and moisture resistant.

### BRIEF DESCRIPTION OF THE DRAWING

Exemplary embodiments of the invention are explained in detail below with reference to the accompanying drawing. The figures show:

FIG. 1 a schematic representation of a driving situation of a user on a light vehicle designed according to the invention when carrying out a method according to the invention;

FIG. 2 a schematic representation of the instances involved in carrying out the methods according to the invention in conjunction with a smartphone configured according to the invention as a wireless communication terminal and a bicycle screen; and

FIG. 3 a flow chart illustrating steps of an exemplary embodiment of a method according to the invention.

### EMBODIMENT OF THE INVENTION

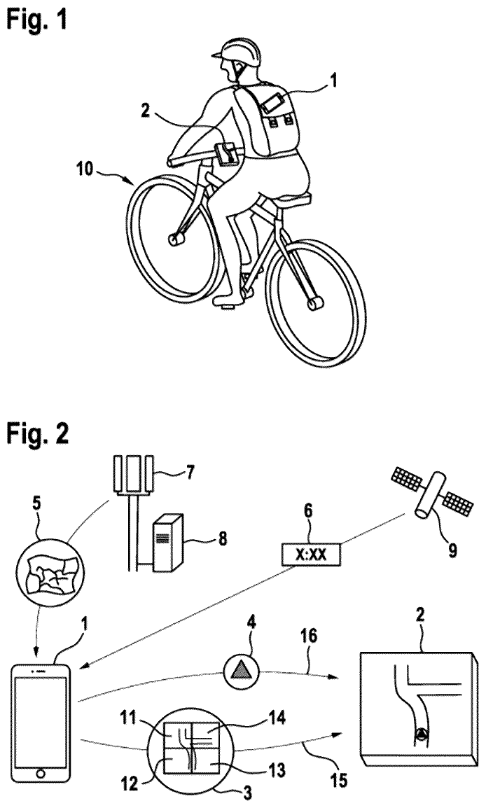

FIG. 1 shows a cyclist riding off-road on a light vehicle 10 in the form of an e-bike. In order to use the software and hardware of his smartphone as a wireless communication terminal 1 for navigation, but not to expose it to dust, liquids and vibrations, he carries the wireless communication terminal 1 in a backpack on his own back that is partially cut out for the sake of clarity. The wireless communication terminal 1 is in wireless communication with a bicycle screen 2 arranged on the handlebars of the e-bike. This is designed to be resistant to liquids, dust and fluids, but has a less powerful processor and no expensive data for map material.

FIG. 2 shows the instances of wireless communication terminal 1 (smartphone) and bicycle screen 2 already presented in FIG. 1, which exchange data packets 3, 4 via two data streams 15, 16. The first data packet 3 comprises four segments 11-14 as components of map material 5, which the wireless communication terminal 1 has received from a stationary server 8 via a transmitter mast 7. For its part, the wireless communication terminal 1 has requested the map material 5 on the basis of data representing an ego position 6, which has been computed by means of a satellite 9. In order to be able to transmit the ego position 6 and the map material 5 to the bicycle screen 2 with the lowest possible bandwidth, the four segments 11-14 are transmitted to the bicycle screen 2 as vector data in the first data packet 3, while the second data packet 4 representing the ego position is transmitted to the bicycle screen 2 as geo-coordinates and is used by it by means of a predefined icon to mark the ego position within a map information.

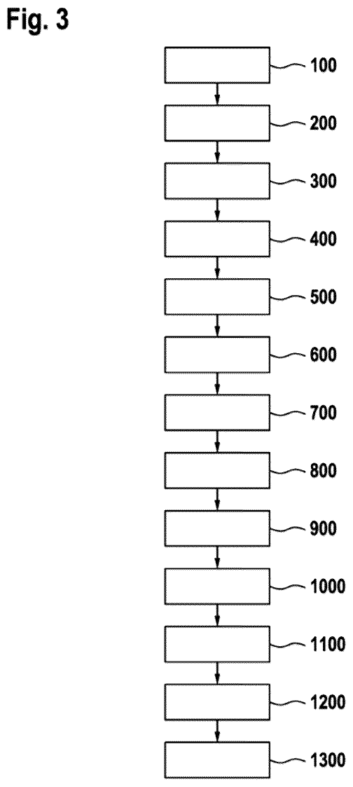

FIG. 3 shows steps of a method for navigation using a portable wireless communication terminal in the form of a smartphone and a bicycle screen, which can be carried out for a navigation plan of a light vehicle. In step 100, a display property of the bicycle screen is determined. Possible display properties include the resolution, aspect ratio, size, etc. of the bicycle screen. The determination can be done using a wireless communication device (smartphone) that is linked to the bicycle screen via data technology. The link can be established via Bluetooth, for example. In step 200, a first data packet representing card information is then computed by means of the wireless communication terminal. In step 300, the first data packet is adjusted based on the display property of the bicycle screen. For example, information can be removed from the first data packet that does not appear suitable for displaying the map due to the display properties of the bicycle screen. In step 400, the first data packet is then transmitted to the bicycle screen by the wireless communication terminal and received by the bicycle screen in step 500. In step 600, the map data just received by means of the first data packet is displayed on the bicycle screen. However, the first data packet did not include an ego position or a marker for the route ahead. For this purpose, a second data packet is computed in step 700 by means of the wireless communication terminal device, which represents an ego position of the wireless communication terminal device and the route ahead of it. The second data packet is transmitted to the bicycle screen in step 800, received by the bicycle screen in step 900 and used in step 1000 to display the ego position and the route ahead on the bicycle screen corresponding to the map information. In step 1100, it is now determined that a segment required for the map information on the bicycle screen is not available or will not be available in the near future (if the route remains unchanged). This can be determined using the bicycle screen, for example, or alternatively or additionally by the wireless communication terminal itself. Therefore, in step 1200, the bicycle screen optionally transmits a request to the wireless communication terminal requesting the required map segment from the wireless communication terminal. Finally, in step 1300, the segment required for the map information is transmitted from the wireless communication terminal to the bicycle screen so that the map to be displayed there is always presented in full. If the wireless communication terminal detects that a segment stored on the bicycle screen is no longer required for a navigation display, it can transmit a command to the bicycle screen to delete the segment.

When the present disclosure refers to a “bicycle screen”, the person skilled in the art also understands this to mean an external display and/or a combination of an evaluation and display unit and/or an electronic control unit linked to or provided with a display unit, which can be arranged on a light vehicle, in particular an electrically propelled light vehicle, for the presentation of a navigation plan during the journey temporarily, semi-temporarily or permanently. In particular, the external display can be set up to engage with a handlebar of the light vehicle by means of a simple snap-in/latch connection. A tool-free or tool-mediated connection between a base and the handlebar of the light vehicle can be provided for this purpose.

1. A method for navigation using a portable wireless communication terminal and a bicycle screen, comprising:
calculating a first data packet by way of the wireless communication terminal representing a map information,
transmitting the first data packet to the bicycle screen,
computing a second data packet by way of the wireless communication terminal representing an ego position of the wireless communication terminal, and
transmitting the second data packet to the bicycle screen.

2. A method for navigation using a portable wireless communication terminal and a bicycle screen, comprising:
receiving a first data packet representing a map information from the wireless communication terminal,
receiving a second data packet representing an ego position of the wireless communication terminal from the wireless communication terminal, and
determining a navigation display based on the first data packet and the second data packet.

3. The method according to claim 2, further comprising:
determining a further navigation display based on a speed characteristic, which is determined using the second data packet.

4. The method according to claim 2, further comprising receiving a further second data packet representing a further ego position and determining a further navigation indication based on the first data packet and the further second data packet.

5. The method according to claim 1, further comprising:
creating a fourth data packet by the wireless communication terminal, which represents (i) an orientation of the map information, and/or (ii) a zoom command, and
transmitting the fourth data packet to the bicycle screen.

6. The method according to claim 1, wherein the first data packet is transmitted to the bicycle screen as vector data and/or rasterized data.

7. The method according to claim 1, wherein the first data packet is transmitted to the bicycle screen on an event basis and the second data packet is transmitted to the bicycle screen at regular time intervals.

8. The method according to claim 1, wherein the first data packet and/or the second data packet are transmitted regularly or irregularly with a frequency of 0.1 Hz to 100 Hz, and/or wherein the second data packet is computed and/or transmitted more frequently than the first data packet.

9. The method according to claim 1, wherein the wireless communication terminal is configured to:
determine the ego position partially or completely independently using its own sensors, and/or
receive the ego position and/or an orientation from a light vehicle and includes it in the second data packet merging it with independently determined ego position information.

10. The method according to claim 1, further comprising:
determining that a segment which is required for the display of the map information on the bicycle screen is not available or will not be available and in response thereto, and
transmitting another first data packet comprising the required segment from the wireless communication terminal to the bicycle screen.

11. The method according to claim 1, further comprising:
determining a navigation display for the bicycle screen based on the further first data packet or based on the first data packet and updated first data packets.

12. The method according to claim 1, further comprising:
determining a display characteristic of the bicycle screen by a light vehicle; and
adjusting the first data packet based on the display properties of the bicycle screen.

13. The method according to claim 1, wherein the second data packet is computed and/or transmitted more frequently than the first data packet.

14. The method according to claim 1, wherein the first data packet has a data volume which corresponds to at least ten times a data volume of the second data packet.

15. An electrically propelled bicycle, which has a bicycle screen and is designed to determine a navigation display for the bicycle screen (2) on the basis of a first data packet (3) and a second data packet, which are configured to be received by way of a communication interface from a wireless communication terminal.

16. The method according to claim 1, wherein the portable wireless communication terminal includes a smartphone.

17. The method according to claim 2, wherein the portable wireless communication terminal includes a smartphone.

18. The method according to claim 1, wherein the first data packet and/or the second data packet are transmitted regularly or irregularly with a frequency of 1-2 Hz and/or wherein the second data packet is computed and/or transmitted one hundred times more frequently than the first data packet.

19. The method according to claim 9, wherein the light vehicle is a pedelec or an S-pedelec or an eBike or the bicycle.

20. The method according to claim 1, wherein the adjusting step includes adjusting a size of the first data packet based on the display properties of the bicycle screen.
